(19) United States
(12) Patent Application Publication
(10) Pub. No.: US 2005/0223087 A1
(43) Pub. Date: Oct. 6, 2005

(54) Quality driving streaming method and apparatus

(75) Inventor: Petrus Desiderius Victor Van Der Stok, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/514,291

(22) PCT Filed: Apr. 22, 2003
(86) PCT No.: PCT/IB03/01550

§ 371 Date: Nov. 12, 2004

(51) Int. Cl. G06F 15/16

(52) U.S. Cl. 709/223; 709/231

(57) ABSTRACT

A method and apparatus for providing quality driven streaming content from a source (102) to a destination terminal (114) in a closed network (100) is disclosed. Every time a new stream is requested information regarding the required bandwidth is gathered. It is then determined if the network has the required bandwidth to transmit the new stream. When the network does not have the required bandwidth, the bandwidth of all streams presently being transmitted is reduced so as to enable the new stream to be sent to the destination terminal (114) when the network does not have the required bandwidth. The bandwidth reduction can be evenly distributed, proportionate based on a stored hierarchy of users, or be performed only on selected streams.

### FIELD OF THE INVENTION

The invention relates to a more efficient use of available bandwidth in a network, and more particularly to a method and apparatus for achieving more efficient use of available bandwidth using capability information provided to a source from a set of source and destination devices.

### BACKGROUND OF THE INVENTION

Networks are progressively penetrating our homes. Most families have installed one or more networks. For example, a network of wired and wireless telephones, a wireless connection to connect loudspeakers to an amplifier, a network to connect equipment to a computer, and a network to interconnect computers.

Interconnecting the equipment within a home greatly enhances the capabilities of the equipment. Given the above situation, such a network will be heterogeneous, i.e., an interconnection of different communication media with different communication protocols. Many standards already address the area of in-home networking such as EEE 1394, HomePNA, CEBus, Home RF, IEEE 802.11, Bluetooth, etc. A well known protocol standard that tackles heterogeneity at the network level is the Internet Protocol (IP).

The network interconnects equipment from the areas of consumer electronics, computing, broadcasting, and telephony. It facilitates entertainment, control, information and communication. For example, it facilitates an audio/video (A/V) stream from a personal computer (PC) to a large screen in the living room. Furthermore, equipment, e.g. heating, can be switched on or off remotely from a mobile telephone, a file can be down-loaded into a computer, and a video conference can be held between parties inside and outside the home.

From the above listed examples, it can be inferred that network access with different resource and timing requirements is needed for: A/V streams with demanding resource, timing and various reliability requirements; control-like access with demanding timing and reliability requirements; file access with weak timing and possibly heavy resource requirements; and conferencing with demanding timing and resource requirements. The user of the network does not want to be bothered with implementation details but does want to be in full control of the devices he knows, such as a set-top box, a PC, or a piece of content such as installation software or a piece of music.

In these networks, many different devices can be operating at the same time or a device can be performing a plurality of different tasks. For example, a screen can have several different windows each displaying different video streams. This may become a problem if too many demands are placed on the network, i.e., the network may not have the capacity or bandwidth to perform all of the requested functions at the same time. This can be a particular problem with streaming content which can be bandwidth expensive. However, in A/V streams, information is often transferred that is in fact not visualized on the destination display or window of the destination screen. Some information is displayed but can be removed, only marginally affecting the user experience. This means that bandwidth is wasted by the transfer of this information. Thus, there is a need for a method and apparatus for more efficiently using the available bandwidth in a network so as to have the ability to provide more services at the same time. Furthermore, there is a need for letting the user decide how the bandwidth should be used when there is not enough bandwidth available for all of the requested implementations.

### SUMMARY OF THE INVENTION

It is an object of the invention to overcome the above-described deficiencies of known networks to provide a more efficient use of the available bandwidth by sending information about the destination displays or windows of destination screens to the controller of the network, wherein the controller can then adapt the content sent to the destination screens to more closely match the capabilities of the screens and the network.

According to one embodiment of the invention, a method and apparatus for providing quality driven streaming content from a source to a destination terminal in a closed network is disclosed. Information about required bandwidth is gathered every time a new stream is requested. Then, it is determined whether the network has the required bandwidth to transmit the new stream. Three methods for bandwidth adaptation are possible.

In a first method, the controller adapts the bandwidth of all streams such that the quality reduction is evenly distributed over all streams without user inventions. A second method is to store a hierarchy of the possible users in the controller. The bandwidth is then more progressively reduced for users that are low on the list and not or little reduced for users high on the list. A third method allows user intervention. The quality of the individual streams is reduced and all users have the possibility to indicate that a further quality decrease cannot be accepted. The controller notes this, and when not enough bandwidth can be liberated for the new stream, the user is informed. Afterwards the social structure within the home determines the bandwidth allocation. At the outcome of the discussions each user has the possibility to signal that further quality reduction is allowed.

According to another embodiment of the invention, a method and apparatus for providing quality driven streaming content from a source to a destination terminal in a closed network is disclosed. Bandwidth is allocated based on network capacity and requirements for specific streams. The requirements for a particular stream are reduced in dependence on the capacity of a destination terminal. The bandwidth of individual streams is reduced when the capacity of the network is insufficient for the addition of a newly requested stream.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 illustrates an illustrative home network for implementing at least one embodiment of the invention;

FIG. 2 illustrates a television with a plurality of windows for simultaneously viewing multiple A/V streams; and

FIG. 3 is a flow chart illustrating the steps the network takes when there is insufficient bandwidth for accomplishing all of the requested implementations according to one embodiment of the invention.

### DETAILED DESCRIPTION OF THE INVENTION

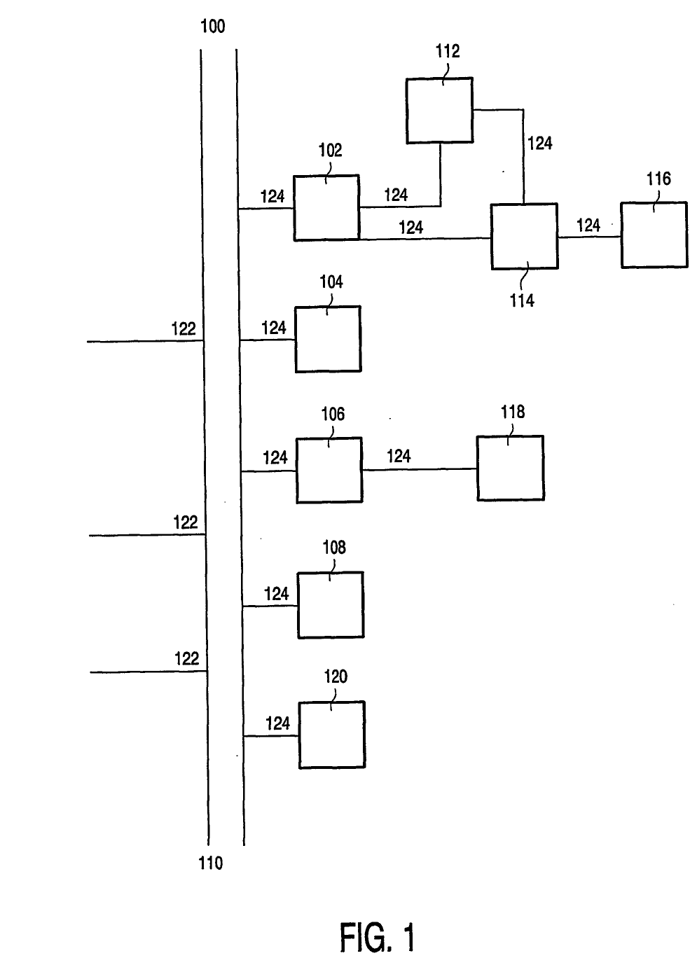

FIG. 1 is a schematic drawings of a home multimedia network 100 constructed in accordance with an embodiment of the invention. This embodiment is exemplary only, however, as the network 100 may be configured in any number of different ways within the scope of the invention, and may include different devices coupled to the network 100. Additionally, the invention is not limited to networks located in homes, but is applicable to other closed networks installed in other types of structures, such as offices, apartment buildings, etc. For purposes of illustration, however, the exemplary embodiment will be described in the context of a home installation.

The network 100 is a digital network that provides connectivity of different types of equipment to the world outside the home. This equipment comprises, for example, a set top box 102, personal computers 104, 106, digital television 114, DVD player 112, digital camcorder 116, audio equipment 118, printer 108, and telephone 120. In addition to connecting this equipment to the outside world, the network 100 also connects the digital video, digital audio, computer and telephone equipment together internally in the home. This unifies communication and control within the home, making the full power of the external network connections or internal data sources available to any terminal on the network 100.

Communication with the outside world is performed through a number of separate network interface units 122 and may be combined physically in an entrance unit (not illustrated, with each network interface unit 122 permitting a connection between a different external network and the home network 100. The different external networks may carry different types of signals. These may be, for example, broadcast signals (digital or mixed analog/digital) carried on hybrid fiber coax or cable. Other types of signals are ISDN, broadcast digital satellite service and others. At least the following data types may be carried: compressed video, compressed audio, compressed internet graphics and data, internet email and other data, computer file data and control message data.

The signals are distributed throughout the home over an internal network 110. In certain embodiments, the internal network 110 is essentially Ethernet of type 10base_T or 100base_T twisted pair but a special switch hub can be employed to make the network scalable to any number of terminal units each able to receive high bit-rate video. For Ethernet networks, a token based protocol can be used to reserve bandwidth. For IEEE 802.11 the EDCF or HCI mechanism can be used. A service discovery mechanism is usually provided by UPnP (universal Plug and Play) or HAVi (home AudioNideo interoperability) standards to allow interoperability between devices.

The HAVi architecture, illustrated in FIG. 1, ensures that products of different vendors can interoperate, i.e., cooperate to perform application tasks. Current consumer electronic devices, such as home entertainment equipment (DVD players 112, DV camcorders 116, digital televisions 114, etc.) are digital processing and digital storage systems. Connecting these devices in networks makes it possible to share processing and storage resources. This allows coordinating the control of several consumer electronic devices simultaneously, e.g., in order to simplify user-interaction. For example, a first device may instantiate recording on a second device while accessing an electronic program guide on a third device. The home network provides the fabric for connecting the consumer electronic devices. It allows connected devices to exchange both control (one device sending a command to another) and A/V data (one device sending an audio or video stream to another device). The network has to meet several requirements in order to achieve all this. It must support timely transfer of high-data-rate AV streams.

The HAVi software architecture is platform-independent and based on Java. HAVi uses the IEEE 1394 high-performance serial bus protocol for transport of control and content among the devices connected to the network. The IEEE 1394 standard is a dynamically configurable, low-cost digital network. IEEE 1394 defines both a backplane physical layer and a point-to-point cable-connected virtual bus implementations. The backplane version operates at 12.5, 25, or 50 Mbits/sec. The cable version has data rates of 100, 200 and 400 Mbits/sec. The standard specifies the media, topology and the protocol. The IEEE 1394 transport protocol is particularly useful for supporting audio and video communication protocols, due to its high data-rate capability.

The HAVi architecture controls the consumer electronic devices in the network through abstract representations of the consumer electronic devices. The abstract representations are operated upon by a controller or source (for example, set top box 102 and personal computers 104, 106) and hide the idiosyncrasies of the associated real consumer electronic devices. The abstract representation thus provides a uniform interface for higher levels of software. The abstract representations are registered with their control properties reflecting those of the device represented. The abstract representations expose their interoperability API's to the applications and collectively form a set of services for building portable, distributed applications on the home network 100. These abstract representations are differently implemented in UPNP.

Both architectures allow a device to send a command or control information to another device in the home network. A HAVi-compliant device contains data (above abstract representation, referred to as Device Control Model) relating to its user-interface and to its control capabilities. This data includes, for example, a HAVi bytecode (Java) that can be uploaded and executed by other devices on the network. A HAVi-compliant device has, as a minimum, enough functionality to communicate with other devices in the system. During interaction, devices may exchange control and data in a peer-to-peer fashion. This ensures that at the communication level, none of the devices is required to act as the master or controller of the system. On the other hand, it allows a logical master or controller to impose a control structure on the basic peer-to-peer communication model. HAVi distinguishes between controllers and controlled devices. A controller is a device that acts as a host for a controlled device. A controller hosts the abstract representation for the controlled device. The control interface is exposed via the API of the abstract representation. This API is the access point for applications to control the device.

HAVi presents the possibility to reserve bandwidth with the aid of a HAVi stream manager that reserves channels on IEEE 1394 communication medium. The application is completely free in allocating part of the channel capacity or the whole capacity to a particular stream. UPNP envisages the ConnectionManager Service to have an overview of all streams between sources and destinations.

Most applications involve a stream of data to be sent from a source to a destination. For example, a stream of A/V is sent from the set top box 102 to the digital television 114. At least the capabilities of the destination limit the quality of the stream perceived by the user. For example, a low resolution screen cannot visualize all aspects of a picture with much detail. The user wants to select the source and the destination from a set of sources and destinations to show his preferred contents with the right quality.

Before the quality parameters of a stream at the destination can be determined, a dialogue between network 100 and a user is needed. In one embodiment of the invention, the network 100 may start the streams with a default quality, wherein the network 100 may have learned the preferences of the user. In case of unexpected situations or on the user's request, a dialogue is started. Especially when multiple streams may overload the capacity of the network 100, the network 100 may provide the user with choices, such that a quality perceived as acceptable by the user can be sustained by the network 100.

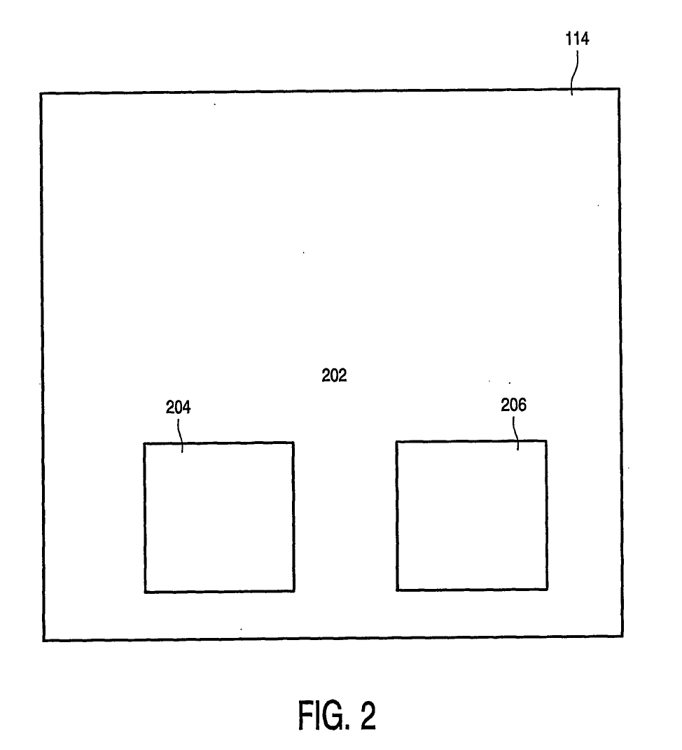

A destination can be a window on a screen but the invention is not limited thereto. A screen can have multiple windows and receive streams from multiple sources. For example, as illustrated in FIG. 2, a main window 202 on a television 114 can be viewed with the highest possible quality, while one or more smaller windows 204, 206 provide information about other incoming streams. Decisions on the viewing quality on the windows can be communicated to the network. The system may automatically change quality and window when a specific event occurs.

The quality of service (QoS) of the network is determined by the qualities of the streams present on the network. The different stages in the transmission of one A/V stream will now be described. At the source, the generated data can be reduced as long as the image quality is not degraded below the required level. This reduction depends on the destination properties and the image properties, as well as the transmission capacity. A weakest link within the whole chain may determine the amount of data reduction and the location of the data reduction. For audio and video, a minimum data rate must be sustained to satisfy the user's wishes. Depending on the contents and chosen encoding, the data rate fluctuates in time. The generated data can be split up in independent streams such that a basic stream allows generation of a moving image with minimum quality requirements. The addition of the other streams stepwise improves the quality of the displayed image. The consequence is a scalable transport algorithm as standardized by the Fine Grained Scalability FGS) part of MPEG4. To every substream a priority, path or redundancy can be allocated to link a probability of delivery with a given quality to a cost function.

A given stream shares the network with other streams. Therefore, part of the bandwidth of the transmission medium is allocated to the given streams. The allocation mechanism is medium dependent. At the destination, the contents of the buffers are sent to the destination at the rate demanded by the contents of the streams. Related streams have to be synchronized and decoded.

As illustrated in FIG. 1, the communication media are interconnected via bridges 124. The media allow the reservation of bandwidth to stream A/V data from a source to a destination. When the stream crosses one or more of the bridges 124, the bandwidth is reserved over all of the involved media. Different media may use different reservation mechanisms. For every bridge 124 there is function T2: medium, medium->bandwidth-characteristics that describes how bandwidth reservation on one medium translates to bandwidth reservation on another medium. A medium has a certain capacity. Knowledge of the capacity of the media can be distributed in two ways: (1) the capacity of the medium is known to all devices connected to the medium, or (2) one or more devices are elected to know the capacity. For each destination, there is a function T1: quantity->quality that describes how a reduction in quantity of stream data affects the quality as perceived by the user.

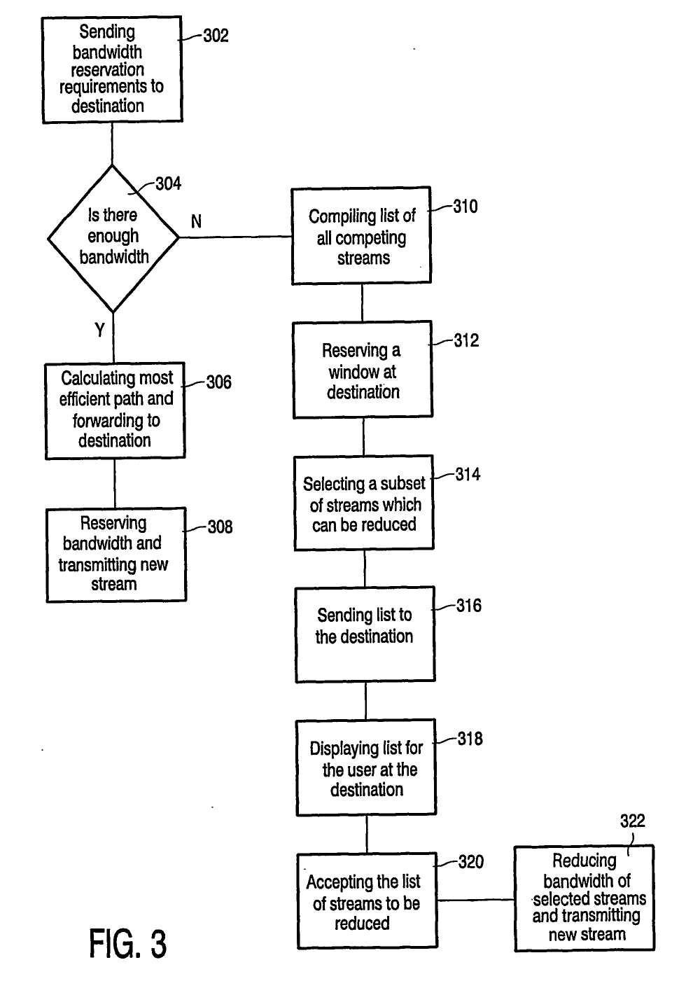

An illustrative example of how the network 100 reacts when there is not enough bandwidth is available to accomplish all of the requested implementations is illustrated in FIG. 3. Every time a new bandwidth reservation is made, the source, for example, set top box 102 and computers 104, 106, sends the bandwidth reservation requirement to the destination over one or more paths if there are any alternatives in step 302. For each path, it is verified whether enough bandwidth is available in step 304. The source calculates the most efficient path and forwards the results of the calculation over the chosen path to the destination in step 306. An alternative is to flood the information over the network. All bandwidth is then reserved and the new stream is transmitted in step 308.

If it is determined in step 304 that not enough bandwidth is available, a list of all competing streams is asked for by the source in step 310. The source lists all streams that arrive at the projected destination of the new stream. The set of streams with this destination is denoted DS. A window is reserved on the destination screen to display the new stream NS in step 312. From the set DS, a subset SDS is determined which will allow enough bandwidth for the new stream if their bandwidths are reduced in step 314. This information is then sent to the destination in step 316.

An interactive dialog can be set up with the user of the destination to display the list of streams which can have their quality reduced to make room for the new stream in step 318. For example the dialog can take place on the window reserved for the new stream. The user can then either accept the changes, cancel the request for the new stream, or request for a different subset of of streams if available in step 320. In addition the user can create a subset SDS and send it back to the source for implementation. The new bandwidth allocations will be sent to the sources of SDS and the new stream will be sent in step 322. In the alternative, the destination can optimize the bandwidth allocation taking into account T1 without prompting the user for the user's input.

If DS is empty, the source can then list all competing streams and their quality levels. The source will then optimize the quality levels on the network without taking into account the functions T1 of the individual streams but based on the functions T2. The source informs the other sources of the adapted bandwidth and sends the new stream. At the destination, an interactive dialog may be started to allow adapting the bandwidth of all involved streams to obtain a user perceived optimum. If a stream must be completely cut to allow the new stream, an interactive dialog with the destination is started which shows a list of all the possible streams which can be cut.

For example, if it is determined that not enough bandwidth is available for the new stream, the system can adapt the bandwidth of all streams such that the quality reduction is evenly distributed over all of the streams without user intervention. Alternatively, the user and/or source creates and stores a hierarchy of the possible users. When it is determined that not enough bandwidth is available for the new stream, the bandwidth of the other streams is then more progressively or proportionately reduces for users that are low on the list ant not or little reduces for users high on the list.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

1. A method for providing quality driven streaming content from a source to a destination terminal in a closed network, comprising the steps of:
gathering information about required bandwidth every time a new stream is requested;
determining if the network has the required bandwidth to transmit the new stream;
reducing the bandwidth of all streams presently being transmitted so as to enable the new stream to be sent to the destination terminal when the network does not have the required bandwidth.

2. The method according to claim 2, wherein the bandwidths of all of the streams are evenly reduced.

3. The method according to claim 1, further comprising the steps of:
storing a hierarchy of possible users;
progressively reducing the bandwidth of streams to users lower on the stored hierarchy more than users higher on the stored hierarchy so as to enable the new stream to be sent to the destination terminal.

4. The method according to claim 1, further comprising the step of:
providing a list of streams that are presently being transmitted to the destination terminal which can be sent with a reduced quality of service.

5. The method according to claim 4, wherein a controller selects streams from the list and reduces the bandwidths of the selected streams so as to enable the new stream to be sent to the destination terminal.

6. The method according to claim 4, further comprising the steps of:
providing the list to a user wherein the user selects streams from the list;
reducing the bandwidths of the selected streams so as to enable the new stream to be sent to the destination terminal.

7. The method according to claim 1, wherein the destination terminal is a display screen.

8. The method according to claim 1, wherein information about required bandwidth is collected when a request to modify an existing stream is received.

9. A method for providing quality driven streaming content from a source to a destination terminal in a closed network, comprising the steps of:
allocating bandwidth based on network capacity and requirements for specific streams;
reducing the requirements for a particular stream in dependence on the capacity of a destination terminal;
reducing the bandwidth of individual streams when the capacity of the network is insufficient for the addition of a newly requested stream.

10. The method according to claim 9, further comprising the step of:
reducing the contents of the streams in dependence on the reduced requirements.

11. The method according to claim 9, further comprising the steps of:
determining if the network has the required bandwidth to transmit the new stream;
providing a list of streams that are presently being transmitted to the destination terminal which can be sent with a reduced quality of service;
reducing the bandwidth of the streams selected from the list so as to enable the new stream to be sent to the destination terminal.

12. The method according to claim 11, wherein a controller of the closed network selects the stream from the list.

13. The method according to claim 11, wherein a user selects the streams from the list.

14. An apparatus for providing quality driven streaming content from a source to a destination terminal in a closed network, comprising:
means for gathering information about required bandwidth every time a new stream is requested;
means for determining if the network has the required bandwidth to transmit the new stream;
means for reducing the bandwidth of all streams presently being transmitted so as to enable the new stream to be sent to the destination terminal when the network does not have the required bandwidth.

15. The apparatus according to claim 14, wherein the bandwidths of all of the streams are evenly reduced.

16. The apparatus according to claim 14, further comprising:
storage means for storing a hierarchy of possible users;
means for progressively reducing the bandwidth of streams to users lower on the stored hierarchy more than users higher on the stored hierarchy so as to enable the new stream to be sent to the destination terminal.

17. The apparatus according to claim 14, further comprising:
means for providing a list of streams that are presently being transmitted to the destination terminal which can be sent with a reduced quality of service.

18. The apparatus according to claim 17, wherein a controller selects streams from the list and reduces the bandwidths of the selected streams so as to enable the new stream to be sent to the destination terminal.

19. The apparatus according to claim 17, further comprising:
means for providing the list to a user wherein the user selects streams from the list;
means for reducing the bandwidths of the selected streams so as to enable the new stream to be sent to the destination terminal.
